(19) United States
(12) Patent Application Publication
(10) Pub. No.: US 2018/0299944 A1
(43) Pub. Date: Oct. 18, 2018

(54) Production Management Method and System Using Power Consumption Features

(71) Applicant: National Tsing Hua University, Hsinchu (TW)

(72) Inventors: Shu-Hao Liang, Taipei City (TW); Ming-Chuan Chiu, Tainan City (TW)

(73) Assignee: National Tsing Hua University

(21) Appl. No.: 15/640,958

(22) Filed: Jul. 3, 2017

(30) Foreign Application Priority Data
Apr. 14, 2017 (TW) 106112512

(51) Int. Cl. G06F 1/32; G06F 11/32; G06Q 10/06; G06Q 50/04

(52) U.S. Cl. CPC G06F 1/3287; G06F 1/3209; G06Q 50/04; G06F 11/327; G06Q 10/06395; G06F 1/3212

(57) ABSTRACT

A production management method and system using power consumption features are described. An electric meter is connected to an equipment machine for measuring power consumption data of the equipment machine. The power consumption data during a processing cycle of the equipment machine is used as a power consumption sample. The power consumption sample is uploaded to a cloud server and a plurality of feature points is set. The power consumption data of the equipment machine is uploaded to the cloud server in real time and compared with the power consumption sample through feature matching, to obtain a facility utilization rate, a production efficiency and a product yield of the equipment machine, so as to calculate an overall equipment effectiveness.

### CROSS-REFERENCE TO RELATED APPLICATION

This application claims priority from Taiwan Patent Application No. 106112512, filed on Apr. 14, 2017, in the Taiwan Intellectual Property Office, the content of which is hereby incorporated by reference in its entirety for all purposes.

### BACKGROUND OF THE INVENTION

### 1. Field of the Invention

The present invention relates to a production management method and system using power consumption features. Particularly, the present invention relates to a method and system, which compare power consumption data of the equipment machine with a power consumption sample of the product during a processing cycle in real time, such that the product is manufactured and managed easily and effectively.

### 2. Description of the Related Art

With the development trend of Industry 4.0, developing the intelligent factory with Internet of Things (IoT) apparatus, having capabilities such as real-time monitoring, communication between machines and big data analysis, will become a basic requirement for enterprises to participate in the whole industrial network so as to effectively use the relevant resources. In order to achieve the above target, according to prior art, current factories are designed to use the supervisory control and data acquisition (SCADA) system. That is, a computer control system is provided with a monitoring program and data collection capability. For example, the switch, the sensor and the controller, etc. are mounted on the existing apparatus for collecting and transmitting the machine data to the database or the cloud sever through a wireless network, and then the software program is executed to analyze the machine data and obtain real-time information or perform big data analysis.

However, spending in the above-mentioned approach includes additional software and hardware costs, personnel training costs and the follow-up maintenance costs. These costs are a large burden on small and medium enterprises, and the benefits may be outweighed by these costs. In addition, since most of the equipment machines in the factory are manufactured from the different manufacturers, the data formats of equipment machines from different manufacturers are generally not compatible with each other, making it necessary for further integration or conversion of the data. Further, most of elder machines do not equip with module of internet connection. As a result, it becomes more difficult to network and coordinate the employed apparatus. Designing Internet of Things (IoT) apparatus and develop an intelligent factory that is key to be able to enhance the production efficiency, by collecting data in a simple and effective way, monitoring and sharing manufacturing data of the equipment machines while keeping the cost of constructing such an intelligent factory affordable.

In view of the above, the inventors of the present invention have developed and designed a production management method and system using power consumption features to improve the aforementioned shortcomings of the prior art so as to enhance industrial applicability.

### SUMMARY OF THE INVENTION

In view of the above-mentioned problems of the conventional art, the object of the present invention is to provide a production management method and system using power consumption features to solve the conventional problems of high construction and maintenance costs due to using the supervisory control and data acquisition (SCADA) system.

One object of the present invention is to provide a production management method using power consumption features, including the following steps: disposing an electric meter connected to an equipment machine for measuring power consumption data of the equipment machine; recording the power consumption data of the equipment machine during a processing cycle in which a workpiece is processed from start to finish, thereby obtaining a power consumption sample; uploading the power consumption sample to a cloud server and setting a plurality of feature points of the power consumption sample; uploading the power consumption data generated by the equipment machine in operation in real time to the cloud server, and comparing the power consumption data with the power consumption sample through feature matching, to obtain a facility utilization rate, a production efficiency and a product yield of the equipment machine; and obtaining an overall equipment effectiveness of the equipment machine from the facility utilization rate, the production efficiency and the product yield.

Preferably, the power consumption data may include a current, a voltage or an output power of the equipment machine.

Preferably, the plurality of feature points may include a plurality of highest output powers and a plurality of lowest output powers of a processing cycle, and a plurality of time points corresponding to the plurality of highest output powers and the plurality of lowest output powers.

Preferably, the production management method using power consumption features may further include the following step: when the power consumption data is compared with the power consumption sample through feature matching, if the plurality of feature points match, the workpiece is recorded as a good product by the cloud server, if the plurality of feature points do not match, the workpiece is recorded as a defective product by the cloud server.

Preferably, the production management method using power consumption features may further include the following step: determining the equipment machine as a standby state by the cloud server, when power consumption data of the equipment machine is lower in value than a preset power consumption and a preset time has not been exceeded; or otherwise, determining the equipment machine as a shutdown state by the cloud server, when the power consumption data is lower in value than a preset power consumption and the preset time has been exceeded.

Another object of the present invention is to provide a production management system using power consumption features, including an equipment machine, an electric meter and a cloud server. The equipment machine is configured to process a workpiece. The electric meter is connected to the equipment machine for measuring power consumption data of the equipment machine. The cloud server is connected to the electric meter through a network, and the cloud server receives the power consumption data which is uploaded instantly from the electric meter and compares the power consumption data with a plurality of feature points of a power consumption sample through feature matching, to obtain a facility utilization rate, a production efficiency and a product yield of the equipment machine, so as to obtain an overall equipment effectiveness of the equipment machine. The power consumption sample is the power consumption data recorded by the electric meter during a processing cycle in which a workpiece is processed from start to finish, and the power consumption sample is uploaded to the cloud server.

Preferably, the power consumption data may include a current, a voltage or an output power of the equipment machine.

Preferably, the plurality of feature points may include a plurality of highest output powers and a plurality of lowest output powers during the processing cycle, and a plurality of time points corresponding to the plurality of highest output powers and the plurality of lowest output powers.

Preferably, the cloud server may generate an alarm message when an abnormality is found in feature matching of the power consumption data and the power consumption sample.

Preferably, the production management system using power consumption features may further include a display device connected to the cloud server for displaying the facility utilization rate, the production efficiency and the product yield of the equipment machine in real time.

As mentioned above, the production management method and system using power consumption features of the present invention may have the one or more of the following advantages:

(1) According to the production management method and system using power consumption features of the present invention, only the electric meter is connected to the equipment machine without disposing the additional sensing device or data collection device, thereby significantly decreasing the construction costs and realizing the construction of the Internet of Things (IoT) apparatus in the simplest manner.

(2) The production management method and system using power consumption features of the present invention is able to obtain the data such as the facility utilization rate, the production efficiency and the product yield and consider the equipment management, the production management and the quality management, etc. at the same time, so as to instantly and effectively integrate the production management data.

(3) The production management method and system using power consumption features of the present invention detect the power consumption data regardless of whether the system or the data processing interface of the equipment machine is compatible or not. Therefore, such method and system are adapted to various types of equipment machines, and thereby improving practicability and compatibility. Furthermore, the controller of the equipment machine may be not directly connected, thereby avoiding affecting the original manufacturing process, and increasing the safety of its use.

### BRIEF DESCRIPTION OF THE DRAWINGS

FIG. 1 is a block diagram of an embodiment of the production management system using power consumption features of the present invention.

FIG. 2 is a flowchart of an embodiment of the production management method using power consumption features of the present invention.

FIG. 3 is a schematic diagram of an embodiment of the setting of the feature points of the present invention.

FIGS. 4A, 4B and 4C are schematic diagrams of an embodiment of feature matching of the present invention.

FIG. 5 is a schematic diagram of another embodiment of the production management system using power consumption features of the present invention.

### DETAILED DESCRIPTION OF THE PREFERRED EMBODIMENTS

For a better understanding of the features, contents and advantages of the present invention, and the effect that may be achieved therefrom, the present embodiments of the present invention are described in more detail as follows with reference to the accompanying drawings. It should be noted that the drawings and exemplary embodiments herein are used for the purpose of illustrating and explaining the present invention, without necessarily implying the actual ratio and the precise configuration. Therefore, in the accompanying drawings, the ratio and the configuration shall not be interpreted in any way that limits the scope of the present invention.

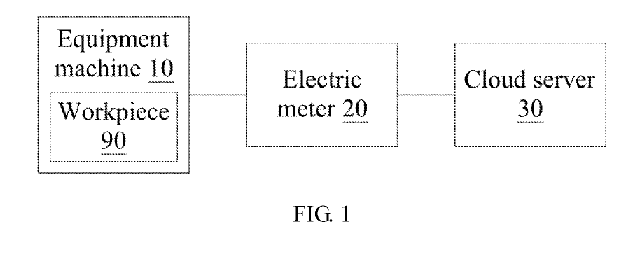

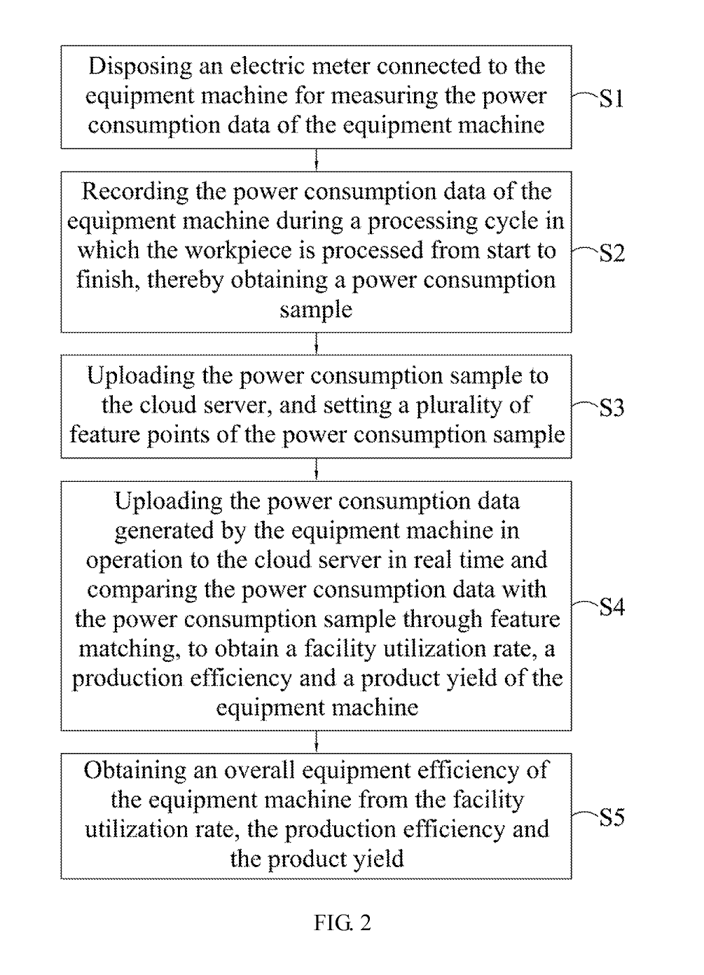

Please refer to FIGS. 1 and 2, FIG. 1 is a block diagram of an embodiment of the production management system using power consumption features of the present invention; FIG. 2 is a flowchart of an embodiment of the production management method using power consumption features of the present invention. As shown in FIG. 1, the production management system using power consumption features includes an equipment machine 10, an electric meter 20 and a cloud server 30. The equipment machine 10 of the present embodiment may include various processing machines such as a press machine and a CNC lathe, etc., which are used to process the workpiece 90, but the present invention is not limited thereto. The production management system using power consumption features of the present invention is also adapted for other equipment machines (such as an injection molding machine) for manufacture. The power supply terminal of the equipment machine 10 is connected to the electric meter 20 for measuring power consumption data of the equipment machine 10. The main power consumption data includes currents and voltages which are supplied to the equipment machine 10. Furthermore, the electric meter 20 also may obtain an output power as the power consumption data. After the equipment machine 10 is activated, the load of the equipment may vary with operational procedure of the machine, and the power consumption data may also vary accordingly. The relevant manufacturing data may be obtained by measuring the power consumption data of the equipment machine 10 by the electric meter 20. The present embodiment may be capable of monitoring the process information by simply analyzing the power consumption data, compared to the conventional art that needs to dispose a switch for turning on and off the equipment machine, a sensor to detect turn on and off events (the duty cycle), a sensor for monitoring a number of the workpieces and an image recognition device for monitoring a product yield, etc. The above-described approach not only decreases the hardware configuration so as to reduce the configuration cost, but also more efficiently obtains data of the production procedure without compatibility problems between the equipment and the data format.

The power consumption data measured by the electric meter 20 is uploaded to the cloud server 30. The cloud server 30 includes a processor for analyzing the data and a database for storing the power consumption data. After the uploaded data is analyzed and compared, the relevant manufacturing information is provided to an operator or supervisor to be further applied for the production management and production arrangement. The production management method using power consumption features corresponding the aforementioned system includes the steps S1˜S5 as shown in FIG. 2, whose contents are described as follows.

At Step S1: disposing an electric meter connected to the equipment machine for measuring the power consumption data of the equipment machine. The equipment machine 10 may process the workpiece 90. The production management data in the production or processing procedure may be obtained from the power consumption data, which is measured by the electric meter 20 connected to the equipment machine 10.

At Step S2: recording the power consumption data of the equipment machine during a processing cycle in which the workpiece is processed from start to finish, thereby obtaining a power consumption sample. In a first production, there is a trial production of general products. At this time, the period in which the workpiece 90 is processed from start to finish is used as a processing cycle of the final product. The power consumption data at each point in time during the processing cycle is recorded as a power consumption sample to be used in the subsequent comparison procedure. The time points during the processing cycle are divided into a plurality of time intervals, in each of which the power consumption data of the equipment machine 10 is recorded. The length of the time intervals may be varied according to the working hours of the different production procedures. Alternatively, a specific time interval may also be directly set and the power consumption data is recorded at the specific time interval.

At Step S3: uploading the power consumption sample to the cloud server, and setting a plurality of feature points of the power consumption sample. The power consumption data collected by the electric meter 20 during the processing cycle is uploaded to the cloud server 30 through a network and stored in the database. For the production procedures of the different workpieces or different products, the power consumption samples are stored in the corresponding database to be used for the subsequent feature matching. In addition, the processor of the cloud server 30 may execute the software application program and set the plurality of feature points of the power consumption sample. For the setting of the feature points, the plurality of highest output powers and the plurality of lowest output powers during the processing cycle and the time points corresponding to the aforementioned power values may be used as the feature points of the power consumption sample. The feature points are described in more detail in the following embodiments.

At Step S4: uploading the power consumption data generated by the equipment machine in operation to the cloud server in real time and comparing the power consumption data with the power consumption sample through feature matching, to obtain a facility utilization rate, a production efficiency and a product yield of the equipment machine. When the equipment machine 10 formally performs the production process, the electric meter 20 continuously measures the power consumption data of the equipment machine 10 at the set time interval, and uploads the power consumption data to the cloud server 30 in real time. At this time, the processor of the cloud server 30 may execute the software application program, and compare the power consumption data, which has just been acquired and uploaded, with the power consumption sample in the database. The comparison is performed by using feature matching for the feature points. The workpiece is recorded as a good product when the feature points match, i.e. that a normal duty cycle has been completed. On the contrary, if one or more feature points do not match during the processing cycle, it is determined that there is at least one abnormality and the workpiece is recorded as a defective product.

At Step S5: obtaining an overall equipment efficiency of the equipment machine from the facility utilization rate, the production efficiency and the product yield. The cloud server 30 not only compares the power consumption data with the power consumption sample, but also continually acquires the power consumption data of the equipment machine during the processing cycle. When the power consumption data (such as a current volume) continues to be lower in value than a preset power consumption, the cloud server 30 may determine a state of the equipment machine depending on a length of the time maintained in low power consumption. When the maintenance time does not exceed the preset time, the equipment machine 10 is determined as a normal standby state and continues to perform another processing cycle after it is refueled or fed. However, if the maintenance time exceeds the preset time, the equipment machine is determined as a shutdown state. At this time, the machine may undergo maintenance while the production line is stopped. For the aforementioned, the cloud server 30 may obtain the facility utilization rate, the production efficiency and the product yield during the process procedure, so as to obtain the overall equipment efficiency of the machine equipment according to the following formula.

Overall equipment efficiency=facility utilization rate×production efficiency×product yield (1)

The facility utilization rate is a percentage of the actual work time in the expected work time. The production efficiency is a rate of the actual production capacity and the expected production capacity. The product yield is a percentage of a number of good products out of a number of actual products. The relationship between the manufacturing management data and feature matching will be described in more detail in the following embodiments.

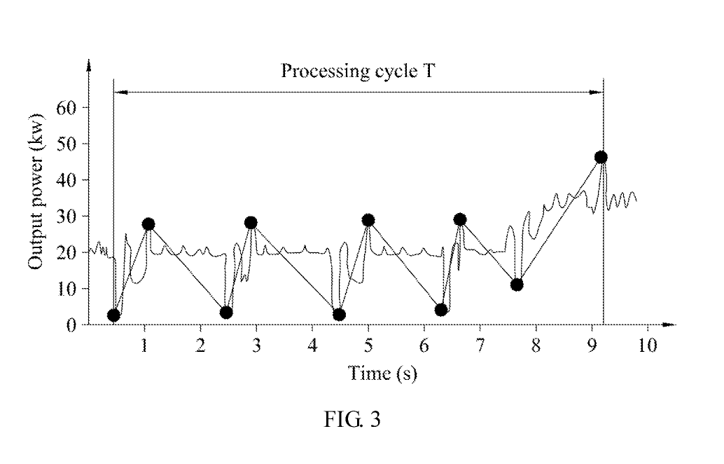

Referring to FIG. 3, which is a schematic diagram of an embodiment of the setting of the feature points of the present invention. As the steps described in the above embodiment, the power consumption data that is generated by the equipment machine at each time axis may be obtained by connecting the electric meter with the equipment machine. In the present embodiment, the output power is used as an example. The generated load may be varied with the different operations performed by the machine. The power consumption data, which is represented by a waveform shown in FIG. 3, may be obtained after the electric meter performs the measurement. Further, the output power value during a processing cycle T, in which the workpiece is processed from start to finish, is captured as the power consumption sample and uploaded to the cloud server. The cloud server may define the feature points in the power consumption sample, depending on the feature points setting rule selected by a user. In the present embodiment, for the setting of the feature points, the highest five points and the lowest five points of the output power at each time interval during the processing cycle are selected. The aforementioned ten time points and the output power values corresponding thereto are used as the feature points of the power consumption sample. The setting rules of the feature points are not limited to the selection manner of the present embodiment. To select the power consumption data at other specific time points is also contained in the category of setting the feature points of the present invention. For example, the largest output power and the smallest output power at the specific time interval are selected as the feature points.

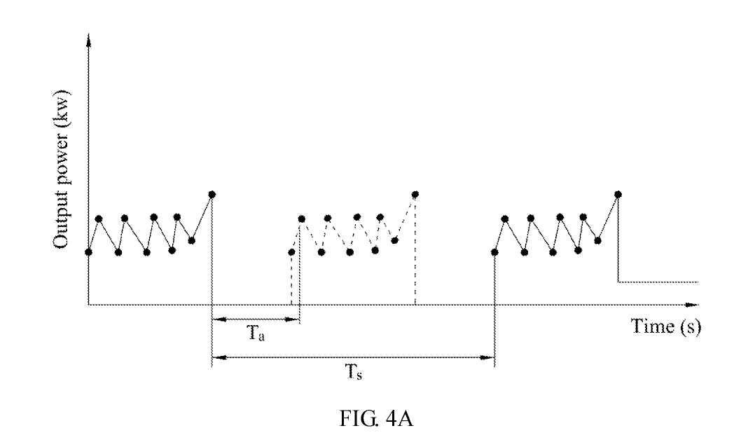

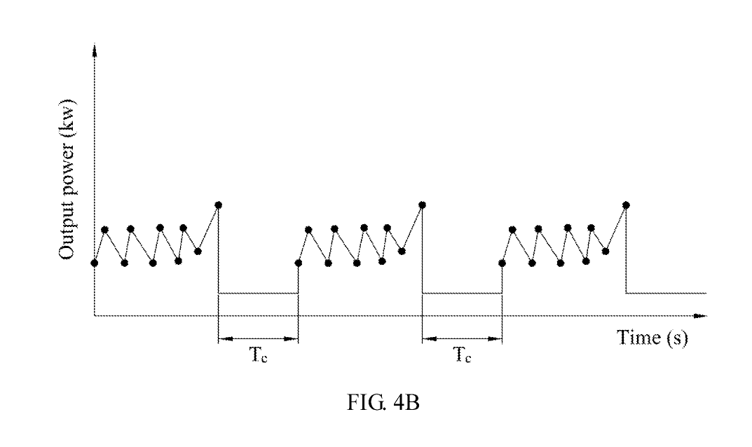

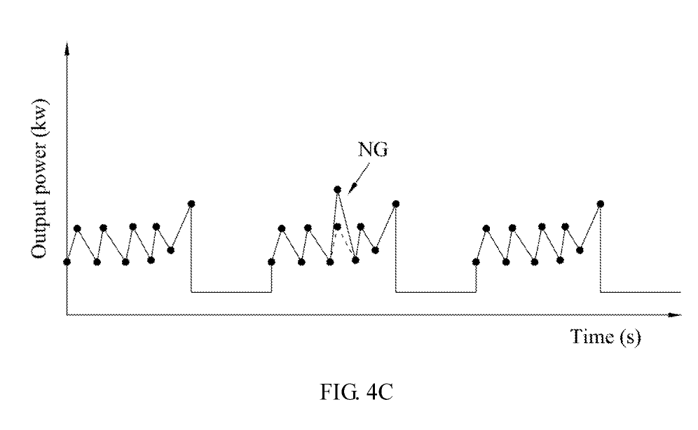

After completing the setting of the feature points of the power consumption sample, the feature points may be stored in the database of the cloud server as standards for feature matching. For the equipment machine, the electric meter may continuously monitor the power consumption data and upload it to the cloud server for feature matching. The cloud server may determine the operation state of the equipment machine and the production state of the product through feature matching, thereby further analyzing the facility utilization rate, the production efficiency and the product yield. The detailed analysis manner is shown in FIGS. 4A to 4C.

Please refer to FIGS. 4A to 4C, which are schematic diagrams of an embodiment of feature matching of the present invention. The comparison results of the different feature points are shown in FIGS. 4A to 4C and described as follows respectively.

As shown in FIGS. 4A and 4B, the power consumption data recorded by the electric meter is an output power along the time axis. FIG. 4A shows the two examples of the power consumption data in conformity with the feature points of the power consumption sample, while FIG. 4B shows three examples of the same. Therefore, the cloud server may determine that the equipment machine carries out the respective process of the two and three workpieces at the time interval shown in FIGS. 4A and 4B. The present embodiment may obtain the actual production of the equipment machine only by analyzing the power consumption data of the equipment machine without additionally mounting a sensor or monitoring device on the machine. Therefore, the production efficiency may be calculated with the lowest hardware requirement and in the most efficient manner. Meanwhile, the production efficiency of the equipment machine may be obtained by comparing the actual production of the equipment machine with the preset production of the schedule. Regarding this, since a cycle time of processing the workpiece is constant, the main factor affecting the production efficiency is a standby time Tc for refueling or feeding. The shorter the standby time Tc is, the higher the production capacity is. On the other hand, the longer the standby time Tc is, the lower the production efficiency is.

The other advantages of monitoring the power consumption data is that not only the production capacity may be calculated, but also the state of the equipment machine may be determined, such that the facility utilization rate of the equipment machine may be monitored. As shown in FIG. 4A, the output power of the equipment machine is zero between the two processing cycles, which is clearly abnormal with respect to the output power at the original standby time Tc. Here, it is determined that the preset power consumption and the preset maintenance time Ta are set, and when the power consumption data is lower in value than the preset power consumption, then whether the maintenance time thereof exceeds the preset value is monitored. If the power consumption data is lower in value than the preset power consumption and the maintenance time does not exceed a preset maintenance time Ta, the equipment machine is determined as a normal standby state. That is, the length of the standby time Tc for refueling or feeding only affects the production efficiency. On the other hand, if the power consumption data is lower in value than the preset power consumption and the maintenance time exceeds the preset maintenance time Ta, the equipment machine is determined as a shutdown state for a shutdown time Ts for maintenance. In this state, the shutdown time Ts not only affects the production efficiency, but also affects the facility utilization rate of the equipment machine. The longer the shutdown time of the equipment machine, then the lower the ratio of the actual work time to the expected work time, resulting in a lower facility utilization rate.

The production management method using power consumption features not only monitors the facility utilization rate and the production efficiency, but also monitors the product yield. Please refer to FIG. 4C, the power consumption data thereof is also an output power along the time axis, which is recorded by the electric meter. However, when the output power of the sixth feature point is found to be different from the power consumption sample through feature matching during the second duty cycle, the cloud server determines that the product produced during this duty cycle is a defective product NG There are various reasons for a mismatch result from feature matching, such as a wrong program is used for processing the workpiece, a wrong placement or configuration of the workpiece material, and others, where these result in a varying power load during the processing procedure. Therefore, when in feature matching there is mismatch, the product during this processing cycle may be determined as abnormal. The cloud server may calculate the production yield rate of the product, depending on a comparison result of a number of the defective products NG and a number of the actual products. The cloud server may further send out an alarm message when the yield rate is less than the preset standard.

For the present method of feature matching, if more than one setting feature point does not match, the product is determined as abnormal. That is, when the power consumption data or the corresponding time points do not match, the product is determined as abnormal. However, in practice, a certain error tolerance range may be set. For example, when a difference between the output power value of the feature points and the power consumption sample is in a range of the power consumption sample of ±3%, the product is determined as normal. The setting range is adjusted for different equipment machines and different product processes, but is not limited to the setting tolerance range of the present embodiment. Furthermore, if the output power values of the power consumption data match while the corresponding time points do not match, the processing velocity of the machine may be adjusted and the error tolerance range of the time points may also be set. When the output power does not exceed the range, it is determined as consistent. Alternatively, new feature points are uploaded to the cloud server, so as to establish new power consumption samples having the different processing velocities to be used for subsequent comparison of the power consumption data.

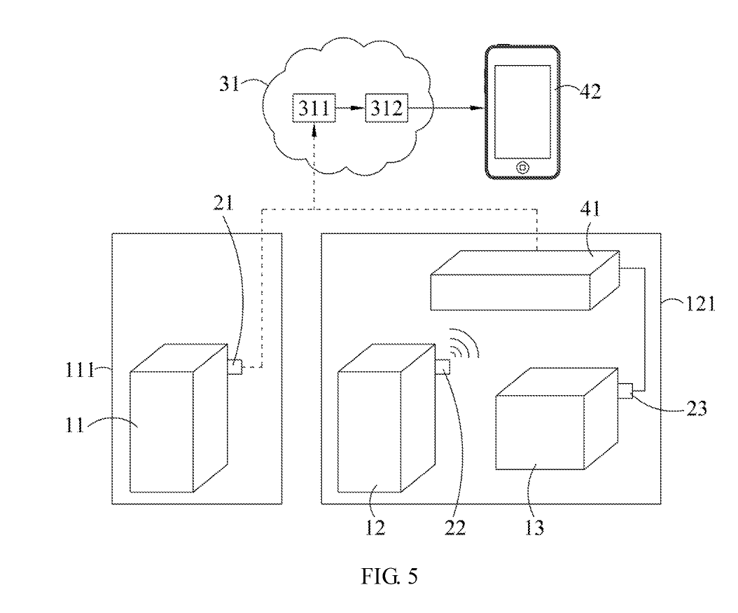

Please refer to FIG. 5, which is a schematic diagram of another embodiment of the production management system using power consumption features. As shown in FIG. 5, the production management system using power consumption features includes a first factory 111 and a second factory 121. The first factory 111 includes a first equipment machine 11. The second factory 121 includes a second equipment machine 12 and a third equipment machine 13. The types of the equipment machines of the present embodiment are similar to those of the above embodiments, and their details are not repeated here. A number of the equipment machines in the actual configuration of the factories may be varied, and are not limited to a number of the present embodiment. The first equipment machine 11 is connected to the first electric meter 21. The second equipment machine 12 and the third equipment machine 13 are connected to the second electric meter 22 and the third electric meter 23 respectively. As described in the above embodiments, the above electric meter measures the power consumption data of each machine and uploads the power consumption data to the cloud server 31 to be compared for monitoring. In the present embodiment, the collection and transmission manner of the power consumption data may include using a data collector 41 of the second factory 121. The power consumption data of the second electric meter 22 and the third electric meter 23 is collected by data collector 41 through the wire or wireless transmission manner and then the power consumption data is uploaded to the database 311 of the cloud server 31. Alternatively, the first electric meter 21 directly has storage and wireless communication functions, etc., such that it is able to directly upload the data to the database 311 of the cloud server 31 and store them therein through the communication network. After performing feature matching to the collected power consumption data by the application program executed in the processor, the production data such as the facility utilization rate, the production efficiency and the product yield is obtained. This data may be instantly transmitted to a display device 42 of the user, such as a cell phone and a tablet computer, whose screens may display the above production data. Similarly, if the comparison result is abnormal, the alarm message indicating abnormality may also be transmitted to the display device 42 to inform the operator or the supervisor to perform the corresponding treatment.

The above first factory 111 and second factory 121 may be disposed in different locations, different regions, or belong to the different companies. However, the processing and production states may be learned from the power consumption data which is uploaded to the cloud server from the electric meter, thereby making the monitoring and control of production efficiency more efficient and flexible. Compared with the conventional supervisory control and data acquisition (SCADA) system, even if the monitoring to the power consumption by the electric meter is included, it is only applied for the energy management of saving energy of the factory. If you desire to obtain the data of the production management or the apparatus management, it is necessary for a further hardware device for monitoring to be disposed, or it is necessary for the captured data of the original machine to be converted into a compatible format. In contrast, the present invention discloses the production management method and system using power consumption features, the method and system replacing the supervisory control and data acquisition (SCADA) system with the simple electric meter configuration and applying a more efficient and instant data collection manner, so as to achieve the target of the manufacturing management. Meanwhile, the present invention not only monitors each machine or the overall factory equipment in real time by the cloud server, but also integrates the power consumption data of each equipment machine and performs big data analysis on the integrated power consumption data. Therefore, the present invention is able to effectively solve the problem of abnormal power consumption features, so as to improve the efficiency of the overall manufacturing procedure.

The above-described embodiments are merely an exemplary illustration, and the present invention is not limited thereto. Any equivalent modification or change may be made thereto without departing from the scope and the spirit of the present invention and is covered by the appended claims.

What is claimed is:

1. A production management method using power consumption features, comprising the following steps:
disposing an electric meter connected to an equipment machine for measuring power consumption data of the equipment machine;
recording the power consumption data of the equipment machine during a processing cycle in which a workpiece is processed from start to finish, to obtain a power consumption sample;
uploading the power consumption sample to a cloud server and setting a plurality of feature points of the power consumption sample;
uploading the power consumption data generated by the equipment machine in operation in real time to the cloud server, and comparing the power consumption data with the power consumption sample through feature matching, to obtain a facility utilization rate, a production efficiency and a product yield of the equipment machine; and
obtaining an overall equipment effectiveness of the equipment machine from the facility utilization rate, the production efficiency and the product yield.

2. The production management method using power consumption features of claim 1, wherein the power consumption data comprises a current, a voltage or an output power of the equipment machine.

3. The production management method using power consumption features of claim 1, wherein the plurality of feature points comprise a plurality of highest output powers and a plurality of lowest output powers during the processing cycle, and a plurality of time points corresponding to the plurality of highest output powers and the plurality of lowest output powers.

4. The production management method using power consumption features of claim 1, comparing the power consumption data with the power consumption sample through feature matching further comprising the following step:
recording the workpiece as a good product by the cloud server, if the plurality of feature points match; and
recording the workpiece as a defective product by the cloud server, if the plurality of feature points do not match.

5. The production management method using power consumption features of claim 1, further comprising the following step:
determining the equipment machine as a standby state by the cloud server, when the power consumption data is lower in value than a preset power consumption and a preset time has not been exceeded; and
determining the equipment machine as a shutdown state by the cloud server, when the power consumption data is lower in value than a preset power consumption and the preset time has been exceeded.

6. A production management system using power consumption features, comprising:
an equipment machine configured to process a workpiece;
an electric meter connected to the equipment machine, and measuring power consumption data of the equipment machine;
a cloud server connected to the electric meter through a network, the cloud server receiving the power consumption data, which is uploaded instantly from the electric meter, and comparing the power consumption data with a plurality of feature points of a power consumption sample through feature matching, to obtain a facility utilization rate, a production efficiency and a product yield of the equipment machine, so as to obtain an overall equipment effectiveness of the equipment machine;
wherein the power consumption sample is the power consumption data recorded by the electric meter during a processing cycle in which the workpiece is processed from start to finish, and the power consumption sample is uploaded to the cloud server.

7. The production management system using power consumption features of claim 6, wherein the power consumption data comprises a current, a voltage or an output power of the equipment machine.

8. The production management system using power consumption features of claim 6, wherein the plurality of feature points comprise a plurality of highest output powers and a plurality of lowest output powers during the processing cycle, and a plurality of time points corresponding to the plurality of highest output powers and the plurality of lowest output powers.

9. The production management system using power consumption features of claim 6, wherein the cloud server generates an alarm message when an abnormality is found in feature matching of the power consumption data and the power consumption sample.

10. The production management system using power consumption features of claim 6, further comprising a display device connected to the cloud server for displaying the facility utilization rate, the production efficiency and the product yield of the equipment machine in real time.
